(19) United States
(12) Patent Application Publication
(10) Pub. No.: US 2016/0089848 A1
(43) Pub. Date: Mar. 31, 2016

(54) STRUCTURES FOR PREVENTNG VACUUM SUCTION WHEN PACKING LIQUID CRYSTAL PANELS

(71) Applicant: Shenzhen China Star Optoelectronics Technology Co. Ltd., Shenzhen, Guangdong (CN)

(72) Inventors: Yunping WANG, Shenzhen, Guangdong (CN); Shihhsiang CHEN, Shenzhen, Guangdong (CN)

(73) Assignee: Shenzhen China Star Optoelectronics Technology Co. Ltd., Shenzhen, Guangdong (CN)

(21) Appl. No.: 14/399,940

(22) PCT Filed: Oct. 9, 2014
(86) PCT No.: PCT/CN2014/088162

§ 371 Date: Nov. 7, 2014

(30) Foreign Application Priority Data
Sep. 26, 2014 (CN) 201410505380.4

(51) Int. Cl. B32B 3/08; B32B 3/30; B32B 3/18

(52) U.S. Cl. CPC B32B 3/085; B32B 3/18; B32B 3/30; B32B 2457/202

(57) ABSTRACT

A structure for preventing vacuum suction when packing liquid crystal panels is disclosed. The structure includes a spaced buffer layer arranged between two liquid crystal panels, a first vacuum breaker structure arranged on a first surface of the spaced buffer layer to form at least one air gap between one of the liquid crystal panel and the spaced buffer layer, and the first surface is opposite to one of the liquid crystal panels. The vacuum suction between the liquid crystal panels and the spaced buffer layer is avoided by arranging the vacuum breaker structures therebetween. As such, the liquid crystal panel is prevented from being brought up by other liquid crystal panel due to the vacuum suction, which avoids the fragment and related cost.

### BACKGROUND OF THE INVENTION

1. Field of the Invention

The present disclosure relates to liquid crystal panel packing technology, and more particularly to a structure for preventing vacuum suction when packing liquid crystal panels.

2. Discussion of the Related Art

Within the manufacturing processes of liquid crystal devices, generally, the components, such as liquid crystal panels, a main control circuit, and housing, are separately packed, and then delivered to corresponding assembling stations.

During the packing process, a buffer layer 20 is arranged between two liquid crystal panels 10, and the buffer layer 20 and the liquid crystal panels 10 are stacked as shown in FIG. 1. However, the closely contacted liquid crystal panels 10 and the buffer layer 20 may result in vacuum suction. As such, taking one liquid crystal panel 10 may bring up the liquid crystal panels 10 arranged below the buffer layer 20, which cause the fragment and damages.

### SUMMARY

In one aspect, a structure for preventing vacuum suction when packing liquid crystal panels includes: a spaced buffer layer arranged between two liquid crystal panels; a first vacuum breaker structure arranged on a first surface of the spaced buffer layer to form at least one air gap between one of the liquid crystal panel and the spaced buffer layer; and wherein the first surface is opposite to one of the liquid crystal panels.

The structure further includes: a second vacuum breaker structure arranged on a second surface of the spaced buffer layer to form at least one air gap between the other liquid crystal panel and the spaced buffer layer; and the second surface is opposite to the other liquid crystal panel.

Wherein the first vacuum breaker structure comprises a plurality of first protrusions arranged in a matrix form on the first surface.

Wherein the first vacuum breaker structure comprises a plurality of stripe grids spaced apart from each other at a fixed distance on the first surface.

Wherein the first vacuum breaker structure comprises a plurality of first protrusions arranged in the matrix form on the first surface, the second vacuum breaker structure comprises a plurality of second protrusions arranged in the matrix form on the second surface.

Wherein the first vacuum breaker structure comprises a plurality of first protrusions arranged in a matrix form on the first surface, the second vacuum breaker structure comprises a plurality of stripe grids spaced apart from each other at a fixed distance on the second surface.

Wherein the first vacuum breaker structure comprises a plurality of first stripe grids spaced apart from each other at a fixed distance on the first surface, and the second vacuum breaker structure comprises a plurality of second protrusions arranged in a matrix form on the second surface.

Wherein the first vacuum breaker structure comprises a plurality of first stripe grids spaced apart from each other at a fixed distance on the first surface, the second vacuum breaker structure comprises a plurality of second stripe grids spaced apart from each other at a fixed distance on the second surface.

Wherein the first vacuum breaker structure is a first spacer formed on the first surface, and the second vacuum breaker structure is a second spacer formed on the second surface, and lengths of the first spacer and the second spacer are smaller than the length of the spaced buffer layer.

Wherein the first vacuum breaker structure comprises a plurality of grooves spaced apart from each other at a fixed distance on the first surface.

The vacuum suction between the liquid crystal panels and the spaced buffer layer is avoided by arranging the vacuum breaker structures therebetween. As such, the liquid crystal panel is prevented from being brought up by other liquid crystal panel due to the vacuum suction, which also avoids the fragment and related cost.

### BRIEF DESCRIPTION OF THE DRAWINGS

FIG. 1 is a schematic view showing the structure of the liquid crystal panels and the buffer layers adopted by one conventional packing method of liquid crystal panels.

FIG. 2 is a schematic view showing the structure for preventing the vacuum suction when packing the liquid crystal panels in accordance with a first embodiment.

FIG. 3 is a top view of the spaced buffer layer having first protrusions with different shapes in accordance with the first embodiment.

FIG. 4 is a top view of the spaced buffer layer having first stripe grids with different shapes in accordance with a second embodiment.

FIG. 5 is a schematic view showing the structure for preventing the vacuum suction when packing the liquid crystal panels in accordance with a third embodiment.

FIG. 6 is a top view of the spaced buffer layer having second protrusions with different shapes in accordance with the third embodiment.

FIG. 7 is a top view of the spaced buffer layer having second stripe grids with different shapes in accordance with the third embodiment.

FIG. 8 is a schematic view showing the structure for preventing the vacuum suction when packing the liquid crystal panels in accordance with a fifth embodiment

FIG. 9 is a schematic view showing the structure for preventing the vacuum suction when packing the liquid crystal panels in accordance with a sixth embodiment.

FIG. 10 is a side view of the spaced buffer layer having grooves with different shapes in accordance with the sixth embodiment.

### DETAILED DESCRIPTION OF THE EMBODIMENTS

Embodiments of the invention will now be described more fully hereinafter with reference to the accompanying drawings, in which embodiments of the invention are shown. Various example embodiments will now be described more fully with reference to the accompanying drawings in which some example embodiments are shown. In the drawings, the thicknesses of layers and regions may be exaggerated for clarity.

It should be noted that the relational terms herein, such as “first” and “second”, are used only for differentiating one entity or operation, from another entity or operation, which, however do not necessarily require or imply that there should be any real relationship or sequence.

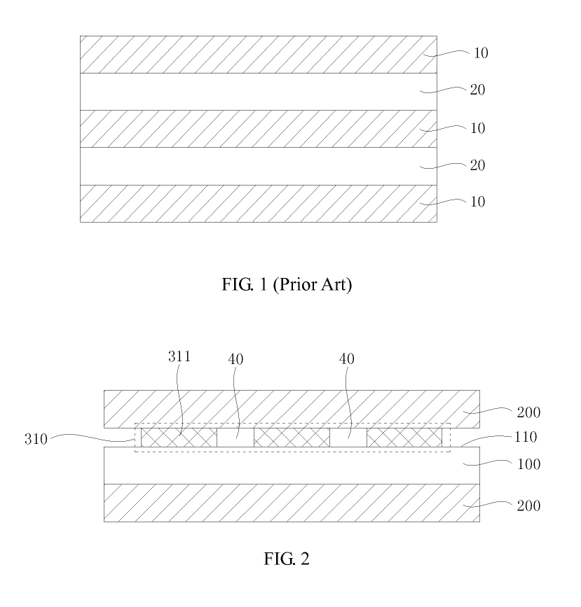

FIG. 2 is a schematic view showing the structure for preventing the vacuum suction when packing the liquid crystal panels (“structure”) in accordance with a first embodiment.

As shown in FIG. 2, the structure includes a spaced buffer layer 100 and a first vacuum breaker structure 310. In an example, one spaced buffer layer 100 and two liquid crystal panels 200 will be described hereinafter. It can be understood that a plurality of spaced buffer layers 100 and a plurality of liquid crystal panels 200 are stacked layer-by-layer in real application.

Specifically, the spaced buffer layer 100 is arranged between two liquid crystal panels 200. The first vacuum breaker structure 310 is arranged on a first surface 100 of the spaced buffer layer 100, and is arranged to be opposite to one of the liquid crystal panels 200. That is, the first surface 100 is arranged to be opposite to one of the liquid crystal panels 200. The first vacuum breaker structure 310 forms an air gap 40 between the spaced buffer layer 100 and one of the liquid crystal panels 200 such that the air may be in between. In this way, the vacuum suction between the spaced buffer layer 100 and one of the liquid crystal panels 200 is avoided. When one of the liquid crystal panel 200 is taken away, the other one of the liquid crystal panel 200 would not be brought up at the same time so as to avoid the fragment and related damages.

The first vacuum breaker structure 310 includes a plurality of first protrusions 311 spaced apart each other on the first surface 100. In an example, the first protrusions 311 are arranged in a matrix form. As the first protrusions 311 are spaced apart from each other, air gaps 40 are formed between the spaced buffer layer 100 and one of the liquid crystal panel 200.

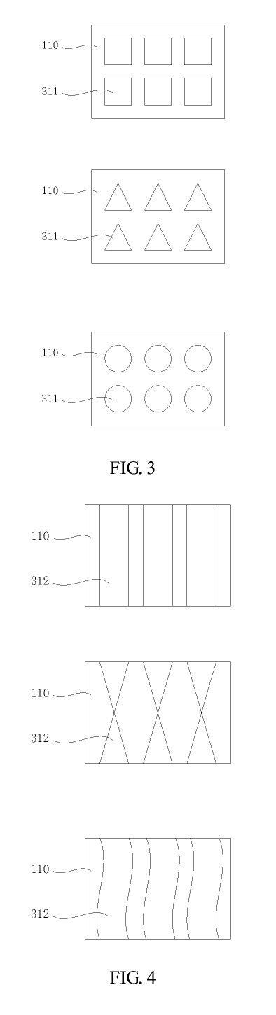

FIG. 3 is a top view of the spaced buffer layer having first protrusions with different shapes in accordance with the first embodiment.

In one example, the first protrusions 311 may be, but not limited to, one of the square, triangular, or circular columns.

The second embodiment will be described hereinafter with reference to FIG. 4. It is to be noted that only those different from the first embodiment will be described. FIG. 4 is a top view of the spaced buffer layer having first stripe grids with different shapes in accordance with the second embodiment.

The first vacuum breaker structure 310 includes a plurality of first stripe grids 312 spaced apart from each other on the first surface 100. In an example, the data driver 312 are spaced apart from each other at a fixed distance. As the first stripe grids 312 are spaced apart from each other, the air gaps 40 are formed between one of the liquid crystal panel 200 and the spaced buffer layer 100.

In the embodiment, the cross section of the first stripe grids 312 may be, but not limited to, rectangular, wave-shaped, or two triangles arranged in a way that the vertexes of the two triangles joint together. It can be understood that the cross section of the first stripe grids 312 may be of other shapes.

The third embodiment will be described hereinafter with reference to FIG. 5. It is to be noted that only those different from the first embodiment will be described. FIG. 5 is a schematic view showing the structure for preventing the vacuum suction when packing the liquid crystal panels in accordance with a third embodiment.

As shown in FIG. 5, the structure further includes a second vacuum breaker structure 320 formed on a second surface 120 of the spaced buffer layer 100. The second vacuum breaker structure 320 is arranged to be opposite to the other liquid crystal panel 200. That is, the second surface 120 is opposite to the other liquid crystal panel 200. The second vacuum breaker structure 320 forms air gaps 40 between the other liquid crystal panel 200 and the spaced buffer layer 100 such that the air may be in between. In this way, the vacuum suction between the spaced buffer layer 100 and the other liquid crystal panel 200 is avoided. When one of the liquid crystal panel 200 is taken away, the other one of the liquid crystal panel 200 would not be brought up at the same time so as to avoid the fragment and related damages.

In this embodiment, the second vacuum breaker structure 320 includes a plurality of second protrusions 321 spaced apart from each other on the second surface 120. In an example, the second protrusions 321 are arranged in a matrix form on the second surface 120. As the second protrusions 321 are spaced apart from each other, air gaps 40 are formed between the spaced buffer layer 100 and any one of the liquid crystal panels 200.

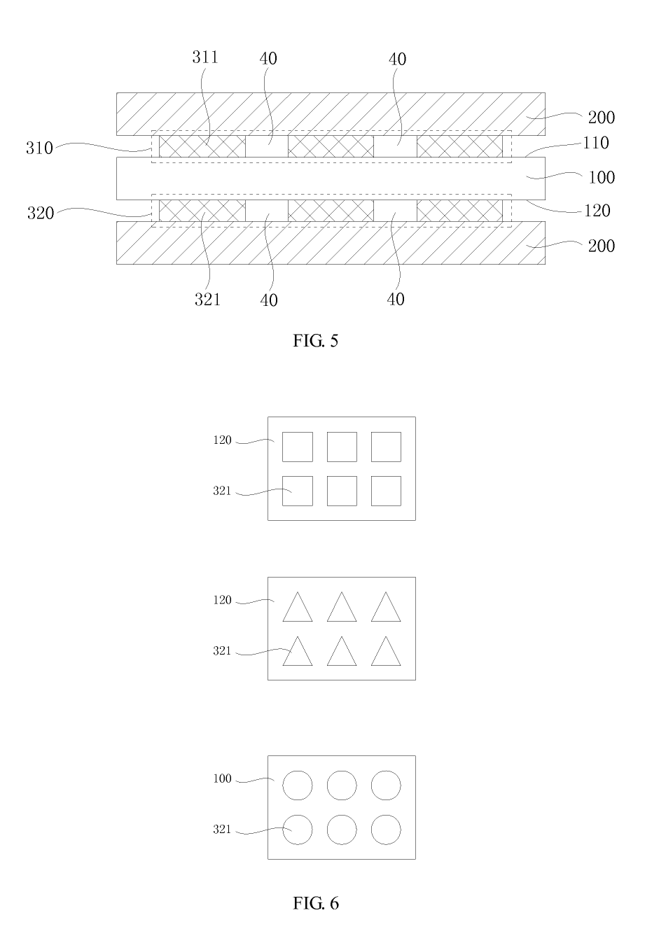

FIG. 6 is a top view of the spaced buffer layer having second protrusions with different shapes in accordance with the third embodiment.

As shown in FIG. 6, the second protrusions 321 may be, but not limited to, one of the square, triangular, or circular columns. It can be understood that in the embodiment, the first surface 100 of the spaced buffer layer 100 may include the first protrusions 311 or the first stripe grids 312. The shape of the first protrusions 311 may be the same with that in the first or second embodiment.

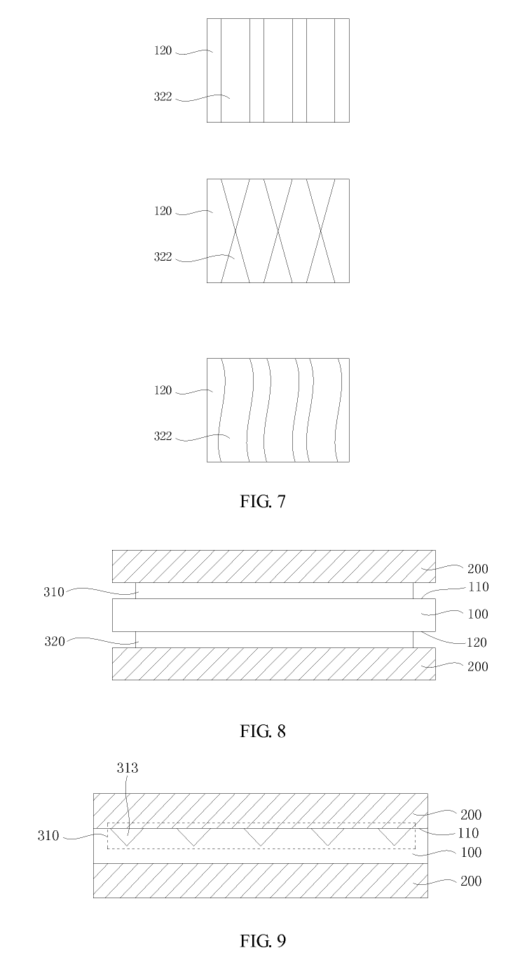

The fourth embodiment will be described hereinafter with reference to FIG. 7. It is to be noted that only those different from the third embodiment will be described. FIG. 7 is a top view of the spaced buffer layer having second stripe grids with different shapes in accordance with the third embodiment.

As shown in FIG. 7, the second vacuum breaker structure 320 includes a plurality of second stripe grids 322 spaced apart from each other on the second surface 120. In an example, the second stripe grids 322 are spaced apart from each other at a fixed distance on the second surface 120. As the second stripe grids 322 are spaced apart from each other, the air gaps 40 are formed between one of the liquid crystal panel 200 and the spaced buffer layer 100.

In the embodiment, the cross section of the second stripe grids 322 may be, but not limited to, rectangular, wave-shaped, or two triangles arranged in a way that the vertexes of the two triangles joint together. It can be understood that the cross section of the second stripe grids 322 may be of other shapes. Also, the first surface 100 of the spaced buffer layer 100 may include the first protrusions 311 or the first stripe grids 312. The shape of the first protrusions 311 may be the same with that in the first or second embodiment.

The fifth embodiment will be described hereinafter with reference to FIG. 8. FIG. 8 is a schematic view showing the structure for preventing the vacuum suction when packing the liquid crystal panels in accordance with a fifth embodiment

The structure in the fifth embodiment includes the spaced buffer layer 100, the first vacuum breaker structure 310, and the second vacuum breaker structure 320.

Specifically, the spaced buffer layer 100 is arranged between two liquid crystal panels 200. The first vacuum breaker structure 310 is arranged on the first surface 100 of the spaced buffer layer 100. The first surface 100 is arranged opposite to one of the liquid crystal panels 200. The second vacuum breaker structure 320 is formed on the second surface 120 of the spaced buffer layer 100. The second surface is opposite to the other liquid crystal panel 200.

In one embodiment, the first vacuum breaker structure 310 may be a first spacer formed on the first surface 110. The second vacuum breaker structure 320 may be a second spacer formed on the second surface 120. In the embodiment, the length of the first spacer and the second spacer are smaller than that of the spaced buffer layer 100. As residual space are formed between the spaced buffer layer 100 and the first spacer and between the spaced buffer layer 100 and the second spacer such that the air may be in between. Thus, the vacuum suction are prevented from being formed between any one of the liquid crystal panel 200 and the spaced buffer layer 100.

The sixth embodiment will be described hereinafter with reference to FIG. 9. It is to be noted that only those different from the first embodiment will be described. FIG. 9 is a schematic view showing the structure for preventing the vacuum suction when packing the liquid crystal panels in accordance with a sixth embodiment.

In the embodiment, the first vacuum breaker structure 310 includes a plurality of grooves 313 spaced apart from each other on the first surface 100. In an example, the grooves 313 are spaced apart from each other at a fixed distance on the first surface 100. The grooves 313 form air gaps between one of the liquid crystal panel 200 and the spaced buffer layer 100.

It can be understood that the second surface 120 of the spaced buffer layer 100 may include the grooves.

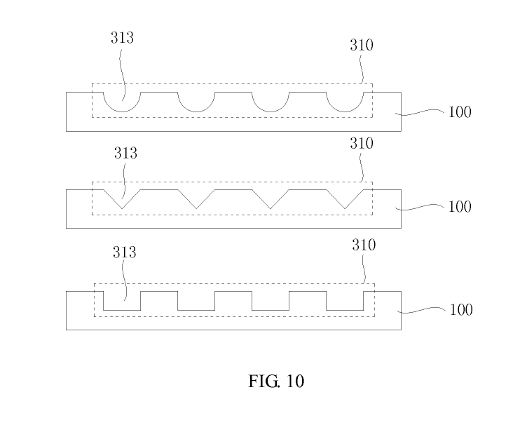

FIG. 10 is a side view of the spaced buffer layer having grooves with different shapes in accordance with the sixth embodiment.

Referring to FIG. 10, the cross sections of the grooves 313 may be, but not limited to, V-shaped, semicircular, or square. It can be understood that the cross section of the first grooves 313 may be of other shapes.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A structure for preventing vacuum suction when packing liquid crystal panels, comprising:
a spaced buffer layer arranged between two liquid crystal panels;
a first vacuum breaker structure arranged on a first surface of the spaced buffer layer to form at least one air gap between one of the liquid crystal panel and the spaced buffer layer; and
wherein the first surface is opposite to one of the liquid crystal panels.

2. The structure as claimed in claim 1, further comprises:
a second vacuum breaker structure arranged on a second surface of the spaced buffer layer to form at least one air gap between the other liquid crystal panel and the spaced buffer layer; and
the second surface is opposite to the other liquid crystal panel.

3. The structure as claimed in claim 1, wherein the first vacuum breaker structure comprises a plurality of first protrusions arranged in a matrix form on the first surface.

4. The structure as claimed in claim 1, wherein the first vacuum breaker structure comprises a plurality of stripe grids spaced apart from each other at a fixed distance on the first surface.

5. The structure as claimed in claim 2, wherein the first vacuum breaker structure comprises a plurality of first protrusions arranged in the matrix form on the first surface, the second vacuum breaker structure comprises a plurality of second protrusions arranged in the matrix form on the second surface.

6. The structure as claimed in claim 2, wherein the first vacuum breaker structure comprises a plurality of first protrusions arranged in a matrix form on the first surface, the second vacuum breaker structure comprises a plurality of stripe grids spaced apart from each other at a fixed distance on the second surface.

7. The structure as claimed in claim 2, wherein the first vacuum breaker structure comprises a plurality of first stripe grids spaced apart from each other at a fixed distance on the first surface, and the second vacuum breaker structure comprises a plurality of second protrusions arranged in a matrix form on the second surface.

8. The structure as claimed in claim 2, wherein the first vacuum breaker structure comprises a plurality of first stripe grids spaced apart from each other at a fixed distance on the first surface, the second vacuum breaker structure comprises a plurality of second stripe grids spaced apart from each other at a fixed distance on the second surface.

9. The structure as claimed in claim 2, wherein the first vacuum breaker structure is a first spacer formed on the first surface, and the second vacuum breaker structure is a second spacer formed on the second surface, and lengths of the first spacer and the second spacer are smaller than the length of the spaced buffer layer.

10. The structure as claimed in claim 1, wherein the first vacuum breaker structure comprises a plurality of grooves spaced apart from each other at a fixed distance on the first surface.
